(19) United States
(12) Patent Application Publication
(10) Pub. No.: US 2010/0082403 A1
(43) Pub. Date: Apr. 1, 2010

(54) ADVOCATE RANK NETWORK & ENGINE

(76) Inventors: Christopher William Higgins, Portland, OR (US); Marc Eliot Davis, San Francisco, CA (US); Ronald Martinez, San Francisco, CA (US); Christopher T. Paretti, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/241,198

(22) Filed: Sep. 30, 2008

(51) Int. Cl. G06Q 30/00; G06Q 90/00; G06N 5/00

(52) U.S. Cl. 705/10; 706/47; 705/14.49

(57) ABSTRACT

This disclosure describes systems and methods for providing real-time and customized advocacy to consumers over a network. Customizing advocacy is done by selecting one or more advocates most likely to induce a potential customer to engage in a transaction with a product, brand, or service. To select these one or more advocates, an advocate ranking is generated, wherein advocates are ranked by a total advocacy value (an estimation of the likelihood that an advocate will induce a potential customer to engage in a transaction with a product, brand, or service). The total advocacy value is determined by monitoring data regarding advocates, and applying that data to a model. The data can be derived from the interactions of real world entities (RWEs) with the network as well as from information objects (IOs) accessible by the network.

### BACKGROUND

Advocacy encompasses any attempt to induce a potential customer to engage in a transaction with a particular product, brand, or service. One form of advocacy is word-of-mouth advocacy which may include verbal communication in person, over the phone, or by electronic message. Advocacy can also include the act of showing a potential customer a product, brand, or service. For example, a potential customer can be taken to a physical store to show and discuss a product, or a potential customer can have an already-purchased product demonstrated to them by an owner of the product. Many other forms of and examples of advocacy are also known.

While advocacy traditionally has been exemplified by in-store salespeople, billboards, magazine advertisements, etc., market research indicates that that there may be more effective ways to advocate a product, brand, or service. For instance, despite the plethora of information available on the Internet, studies show that potential customers still prefer human interaction when making a purchase. Consumers are also more likely to heed the recommendations or influences of friends, family, co-workers, and others having social relationships with the Consumer. Potential customers are also highly-influenced by those in their peer group. Systems and method for taking advantage of these facts are currently limited.

### SUMMARY

This disclosure describes systems and methods for providing real-time and customized advocacy to consumers over a network. One aspect of the disclosure is a method comprising: receiving a request over a network for a determination of an advocate rank relative to an item and a prospect; identifying one or more advocates having an association with the prospect and the item; determining, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item; ranking, via a processor, each advocate according to each advocate's total advocacy value; and providing the advocates' ranking over the network in response to the request. Another aspect of the present disclosure comprises facilitating communication between one or more highest-ranked advocates and the prospect wherein the highest-ranked advocates are selected based on the advocates' ranking. Another aspect of the present disclosure comprises the model comprising a prospective advocacy value for each advocate, wherein the prospective advocacy value represents the quality of a relationship between each advocate and the prospect. Another aspect of the present disclosure involves the quality being based on user-defined relationships and autonomously-derived relationships. Another aspect of the present disclosure involves the quality being based on an intimacy of the relationship between the advocate and prospect, and a frequency of communication between the advocate and prospect. Another aspect of the present disclosure involves the model comprising an item advocacy value, wherein the item advocacy value represents the quality of the relationship between each advocate and the item. In another aspect of the present the item advocacy value is the dollar value of the item. Another aspect of the present disclosure involves determining an item advocacy value, wherein the model gives different weight to each advocate's prior advocating activities depending on a type of prior advocacy. Another aspect of the present disclosure involves determining an item advocacy value, wherein the model gives different weight to each advocate's prior advocating activities depending on actual results of the prior advocating activities. Another aspect of the present disclosure involves determining an item advocacy value, wherein the model gives different weight to each advocate's prior advocating activities depending on the value of prior advocating activities. In another aspect of the present disclosure the quality is based on a co-presence of the advocate and a previous prospect. In another aspect of the present disclosure co-presence is virtual. In another aspect of the present disclosure co-presence is physical. Another aspect of the present disclosure involves predicting a most valuable time at which advocacy is most likely to induce a transaction; and facilitating communication between one or more of the highest-ranked advocates and the prospect at a time based on the most valuable time. In another aspect of the present disclosure an advocates' ranking is determined for each product, brand, or service related to the item. In another aspect of the present the advocates' ranking is determined for one or more Who, What, Where, When clouds of the W4 COMN. In another aspect of the present disclosure information includes the spatial relation between the advocate and the prospect. In another aspect of the present disclosure the spatial relation between the advocate and the prospect is determined via monitoring one or more RFID tags associated with an RWE, wherein the RWE is associated with a prospect.

Another aspect of the present disclosure involves monitoring an advocate, via a network, for evidence of advocacy; observing evidence of advocacy; determining, via a processor, a value of the advocacy by applying to a model information available via the network derived from real world entities' (RWEs) interactions with the network and information objects (IOs) accessible by the network; and compensating the advocate based on the value of the advocacy. Another aspect of the present disclosure involves compensating the advocate when the prospect or value of the advocacy satisfies an advertiser's conditions. In another aspect of the present disclosure the advertiser's conditions include one or more of the following: making a purchase, signing up for a membership, signing up for a newsletter, signing up to be on an e-mail list, visiting a virtual store, visiting a physical store, testing a product, and taking a survey.

Another aspect of the present disclosure involves an advocate rank engine having an advocate identification module that receives a request over a network for a determination of an advocate rank relative to an item, and identifies one or more advocates having an association with the prospect and the item; a total advocacy value determining module that determines, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item; a ranking module that ranks each advocate according to each advocate's total advocacy value; and a ranking distribution module that provides the advocates' ranking over the network in response to the request. Another aspect of the present disclosure involves an advocate compensation module. In another aspect of the present disclosure the ranking module determines an advocates' ranking for every advertiser. In another aspect of the present disclosure the ranking module determines an advocates' ranking for every brand. In another aspect of the present disclosure the ranking module determines an advocates' ranking for every prospect. In another aspect of the present disclosure the total advocacy value determining module determines total advocacy value based on the advocate, advertiser, prospect, transaction type, and transaction value. Another aspect of the present disclosure involves an advertiser manager capable of: receiving data describing an advertisement campaign of an advertiser; and matching advocates to the advertiser as part of the advertisement campaign based upon each advocate's rank.

Another aspect of the present disclosure involves a computer readable media or medium tangibly comprising computer readable instructions for: receiving a request over a network for a determination of an advocate rank relative to an item; identifying one or more advocates having an association with a prospect and the item; determining, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item; ranking, via a processor, each advocate according to each advocate's total advocacy value; and providing the advocates' ranking over the network in response to the request. Another aspect of the present disclosure involves the computer readable tangibly comprising computer readable instructions for: monitoring an advocate, via a network, for evidence of advocacy; observing evidence of advocacy; determining, via a processor, a value of the advocacy by applying to a model information available via the network derived from RWEs' interactions with the network and IOs accessible by the network; and compensating the advocate based on the value of the advocacy.

Another aspect of the present disclosure involves a method comprising: receiving a request over a network for a determination of an advocate rank relative to an item; identifying one or more advocates having an association with the prospect and the item; determining, via a processor, a value of the advocacy by applying to a model information available via the network derived from real world entities' (RWEs) interactions with the network and information objects (IOs) accessible by the network; ranking, via a processor, each advocate according to each advocate's total advocacy value; and providing the advocates' ranking over the network in response to the request. In another aspect of the present disclosure the advocates' ranking is determined relative to the prospect.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates relationships between real-world entities (RWE) and information objects (IO) on one embodiment of a W4 Communications Network (W4 COMN.)

FIG. 2 illustrates metadata defining the relationships between RWEs and IOs on one embodiment of a W4 COMN.

FIG. 3 illustrates a conceptual model of one embodiment of a W4 COMN.

FIG. 4 illustrates the functional layers of one embodiment of the W4 COMN architecture.

FIG. 5 illustrates the analysis components of one embodiment of a W4 engine as shown in FIG. 2.

FIG. 6 illustrates one embodiment of a W4 engine showing different components within the sub-engines shown in FIG. 5.

FIG. 7 illustrates one embodiment of a method for ranking advocates that are identified as having an association with a prospect and an item, and providing this ranking over a network.

FIG. 8 illustrates one embodiment of a method for monitoring advocacy and compensating advocates based on the value of their observed advocacy.

FIG. 9 illustrates one embodiment of an advocate rank engine.

### DETAILED DESCRIPTION

This disclosure describes systems and methods for providing real-time and customized advocacy to consumers over a network. Customizing advocacy is done by selecting one or more advocates most likely to induce a potential customer to engage in a transaction with a product, brand, or service. To select these one or more advocates, an advocate ranking is generated, wherein advocates are ranked by a total advocacy value (an estimation of the likelihood that an advocate will induce a potential customer to engage in a transaction with a product, brand, or service). The total advocacy value is determined by monitoring data regarding advocates, and applying that data to a model. The data can be derived from the interactions of real world entities (RWEs) with the network as well as from information objects (IOs) accessible by the network.

Based on the advocate ranking, in an embodiment, communication can be facilitated between one or more highest-ranked advocates and the potential customer. In another embodiment, advocates can be compensated for their advocacy. The amount of compensation can be based on a value of the advocate's advocacy.

For the purposes of this disclosure, a consumer or potential customer will be referred to using the term “prospect.” By way of example, and not limitation, the term “prospect” can refer to any person interested in making a purchase of any product, brand, or service.

For the purposes of this disclosure, any person who advocates a product, brand, or service will be referred to using the term “advocate.” By way of example, and not limitation, the term “advocate” can refer to any person that an advertiser deems to be an advocate.

For the purposes of this disclosure, any product, brand, or service will be referred to using the term “item.” By way of example, and not limitation, the term “item” can refer to tangible products or goods such as running shoes, books, and cars, to name a few. By way of example, and not limitation, the term “item” can refer to intangible products or goods such as MP3s, electronic books, and massive-multiplayer avatars, to name a few. By way of example, and not limitation, the term “item” can refer to brands such as NIKE, GOOGLE, and HALLMARK, to name a few. By way of example, and not limitation, the term “item” can refer to a services such as online banking, dry cleaning, and yoga instruction, to name a few.

For the purposes of this disclosure, any ranking of one or more advocates will be referred to using the term “advocates' ranking.” By way of example, and not limitation, the term “advocates' ranking” can refer to data representing an ordered listing of advocates, wherein the order is based on each advocate's total advocacy value.

For the purposes of this disclosure, a “total advocacy value” is an element of data that can be stored on a computer readable media or medium and that represents the likelihood that an advocate can induce a prospect to engage in a transaction.

For the purposes of this disclosure, a “model” should be understood to refer to one or more algorithms, functions, equations, or systems capable of receiving data and transforming said data into useful output data.

For the purposes of this disclosure, a “processor” should be understood to refer to a logic machine or component of a computing system capable of executing computer programs or instructions.

For the purposes of this disclosure, a “computer system” should be understood to refer to a system or device inclusive of a processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure the term “media” and “media content” should be understood to refer to binary data which contains content which can be of interest to an end user. By way of example, and not limitation, the term “media” and “media content” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be encrypted, compressed, and/or can contained embedded metadata.

For the purposes of this disclosure, a “computer readable medium” or “computer readable media” stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium. Modules can be integral to one or more servers, or be loaded and executed by one or more servers. One or more modules can grouped into an engine or an application.

Embodiments of the present invention utilize information provided by a network which is capable of providing data collected and stored by multiple devices on a network. Such information may include, without limitation, temporal information, spatial information, and user information relating to a specific user or hardware device. User information may include, without limitation, user demographics, user preferences, user social networks, and user behavior. One embodiment of such a network is a W4 Communications Network.

A “W4 Communications Network” or W4 COMN, provides information related to the “Who, What, When and Where” of interactions within the network. In one embodiment, the W4 COMN is a collection of users, devices and processes that foster both synchronous and asynchronous communications between users and their proxies providing an instrumented network of sensors providing data recognition and collection in real-world environments about any subject, location, user or combination thereof.

In one embodiment, the W4 COMN can handle the routing/addressing, scheduling, filtering, prioritization, replying, forwarding, storing, deleting, privacy, transacting, triggering of a new message, propagating changes, transcoding and linking. Furthermore, these actions can be performed on any communication channel accessible by the W4 COMN.

In one embodiment, the W4 COMN uses a data modeling strategy for creating profiles for not only users and locations, but also any device on the network and any kind of user-defined data with user-specified conditions. Using Social, Spatial, Temporal and Logical data available about a specific user, topic or logical data object, every entity known to the W4 COMN can be mapped and represented against all other known entities and data objects in order to create both a micro graph for every entity as well as a global graph that relates all known entities with one another. In one embodiment, such relationships between entities and data objects are stored in a global index within the W4 COMN.

In one embodiment, a W4 COMN network relates to what may be termed “real-world entities”, hereinafter referred to as RWEs. A RWE refers to, without limitation, a person, device, location, or other physical thing known to a W4 COMN. In one embodiment, each RWE known to a W4 COMN is assigned a unique W4 identification number that identifies the RWE within the W4 COMN.

RWEs can interact with the network directly or through proxies, which can themselves be RWEs. Examples of RWEs that interact directly with the W4 COMN include any device such as a sensor, motor, or other piece of hardware connected to the W4 COMN in order to receive or transmit data or control signals. RWE may include all devices that can serve as network nodes or generate, request and/or consume data in a networked environment or that can be controlled through a network. Such devices include any kind of “dumb” device purpose-designed to interact with a network (e.g., cell phones, cable television set top boxes, fax machines, telephones, and radio frequency identification (RFID) tags, sensors, etc.).

Examples of RWEs that may use proxies to interact with W4 COMN network include non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) may be considered RWE that use proxies to interact with the network, where software applications executing on the device that serve as the devices' proxies.

In one embodiment, a W4 COMN may allow associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 COMN.

An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association can include the user identifying a specific relationship between the user and the RWE (e.g., this is my device, this is my home appliance, this person is my friend/father/son/etc., this device is shared between me and other users, etc.). RWEs can also be implicitly associated with a user based on a current situation. For example, a weather sensor on the W4 COMN can be implicitly associated with a user based on information indicating that the user lives or is passing near the sensor's location.

In one embodiment, a W4 COMN network may additionally include what may be termed “information-objects”, hereinafter referred to as IOs. An information object (IO) is a logical object that may store, maintain, generate or otherwise provides data for use by RWEs and/or the W4 COMN. In one embodiment, data within in an IO can be revised by the act of an RWE An IO within in a W4 COMN can be provided a unique W4 identification number that identifies the IO within the W4 COMN.

In one embodiment, IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In one embodiment, IOs include any executing process or application that consumes or generates data such as an email communication application (such as OUTLOOK by MICROSOFT, or YAHOO! MAIL by YAHOO!), a calendaring application, a word processing application, an image editing application, a media player application, a weather monitoring application, a browser application and a web page server application. Such active IOs can or can not serve as a proxy for one or more RWEs. For example, voice communication software on a smart phone can serve as the proxy for both the smart phone and for the owner of the smart phone.

In one embodiment, for every IO there are at least three classes of associated RWEs. The first is the RWE that owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs that access the IO in order to obtain data from the IO for some purpose.

Within the context of a W4 COMN, “available data” and “W4 data” means data that exists in an IO or data that can be collected from a known IO or RWE such as a deployed sensor. Within the context of a W4 COMN, “sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

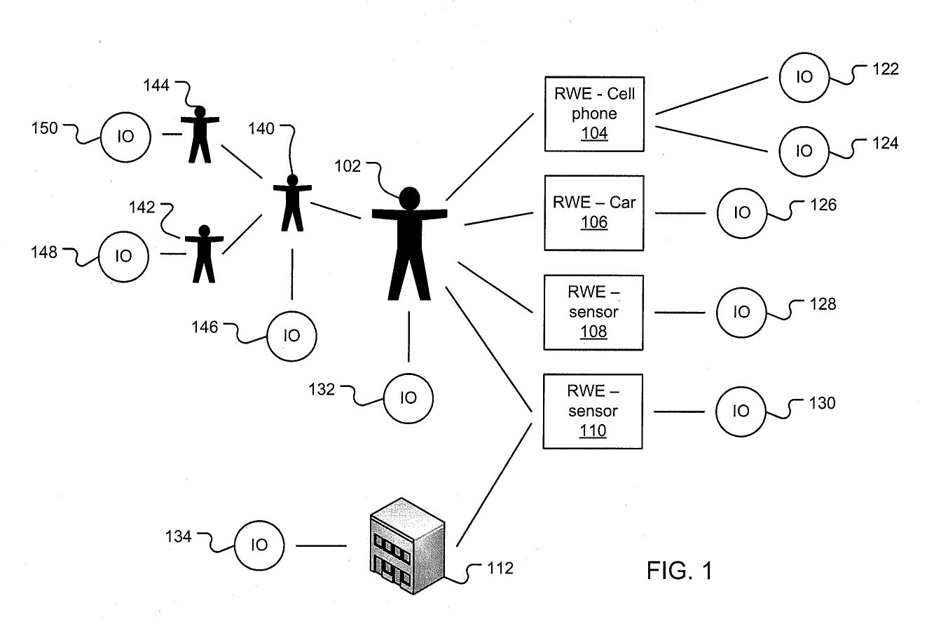

FIG. 1 illustrates one embodiment of relationships between RWEs and IOs on a W4 COMN. A user 102 is a RWE provided with a unique network ID. The user 102 may be a human that communicates with the network using proxy devices 104, 106, 108, 110 associated with the user 102, all of which are RWEs having a unique network ID. These proxies can communicate directly with the W4 COMN or can communicate with the W4 COMN using IOs such as applications executed on or by a proxy device.

In one embodiment, the proxy devices 104, 106, 108, 110 can be explicitly associated with the user 102. For example, one device 104 can be a smart phone connected by a cellular service provider to the network and another device 106 can be a smart vehicle that is connected to the network. Other devices can be implicitly associated with the user 102.

For example, one device 108 can be a “dumb” weather sensor at a location matching the current location of the user's cell phone 104, and thus implicitly associated with the user 102 while the two RWEs 104, 108 are co-located. Another implicitly associated device 110 can be a sensor 110 for physical location 112 known to the W4 COMN. The location 112 is known, either explicitly (through a user-designated relationship, e.g., this is my home, place of employment, parent, etc.) or implicitly (the user 102 is often co-located with the RWE 112 as evidenced by data from the sensor 110 at that location 112), to be associated with the first user 102.

The user 102 can be directly associated with one or more persons 140, and indirectly associated with still more persons 142, 144 through a chain of direct associations. Such associations can be explicit (e.g., the user 102 can have identified the associated person 140 as his/her father, or can have identified the person 140 as a member of the user's social network) or implicit (e.g., they share the same address). Tracking the associations between people (and other RWEs as well) allows the creation of the concept of “intimacy”, where intimacy may be defined as a measure of the degree of association between two people or RWEs. For example, each degree of removal between RWEs can be considered a lower level of intimacy, and assigned lower intimacy score. Intimacy can be based solely on explicit social data or can be expanded to include all W4 data including spatial data and temporal data.

In one embodiment, each RWE 102, 104, 106, 108, 110, 112, 140, 142, 144 of a W4 COMN can be associated with one or more IOs as shown. FIG. 1 illustrates two IOs 122, 124 as associated with the cell phone device 104. One IO 122 can be a passive data object such as an event record that is used by scheduling/calendaring software on the cell phone, a contact IO used by an address book application, a historical record of a transaction made using the device 104 or a copy of a message sent from the device 104. The other IO 124 can be an active software process or application that serves as the device's proxy to the W4 COMN by transmitting or receiving data via the W4 COMN. Voice communication software, scheduling/calendaring software, an address book application or a text messaging application are all examples of IOs that can communicate with other IOs and RWEs on the network. IOs may additionally relate to topics of interest to one or more RWEs, such topics including, without limitation, musical artists, genre of music, a location and so forth.

The IOs 122, 124 can be locally stored on the device 104 or stored remotely on some node or datastore accessible to the W4 COMN, such as a message server or cell phone service datacenter. The IO 126 associated with the vehicle 108 can be an electronic file containing the specifications and/or current status of the vehicle 108, such as make, model, identification number, current location, current speed, current condition, current owner, etc. The IO 128 associated with sensor 108 can identify the current state of the subject(s) monitored by the sensor 108, such as current weather or current traffic. The IO 130 associated with the cell phone 110 can be information in a database identifying recent calls or the amount of charges on the current bill.

RWEs which can only interact with the W4 COMN through proxies, such as people 102, 140, 142, 144, computing devices 104, 106 and locations 112, can have one or more IOs 132, 134, 146, 148, 150 directly associated with them which contain RWE-specific information for the associated RWE. For example, IOs associated with a person 132, 146, 148, 150 can include a user profile containing email addresses, telephone numbers, physical addresses, user preferences, identification of devices and other RWEs associated with the user. The IOs may additionally include records of the user's past interactions with other RWE's on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.).

Another example of IOs associated with a person 132, 146, 148, 150 includes remote applications through which a person can communicate with the W4 COMN such as an account with a web-based email service such as Yahoo! Mail. A location's IO 134 can contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In one embodiment, RWEs and IOs are correlated to identify relationships between them. RWEs and IOs may be correlated using metadata. For example, if an IO is a music file, metadata for the file can include data identifying the artist, song, etc., album art, and the format of the music data. This metadata can be stored as part of the music file or in one or more different IOs that are associated with the music file or both. W4 metadata can additionally include the owner of the music file and the rights the owner has in the music file. As another example, if the IO is a picture taken by an electronic camera, the picture can include in addition to the primary image data from which an image can be created on a display, metadata identifying when the picture was taken, where the camera was when the picture was taken, what camera took the picture, who, if anyone, is associated (e.g., designated as the camera's owner) with the camera, and who and what are the subjects of/in the picture. The W4 COMN uses all the available metadata in order to identify implicit and explicit associations between entities and data objects.

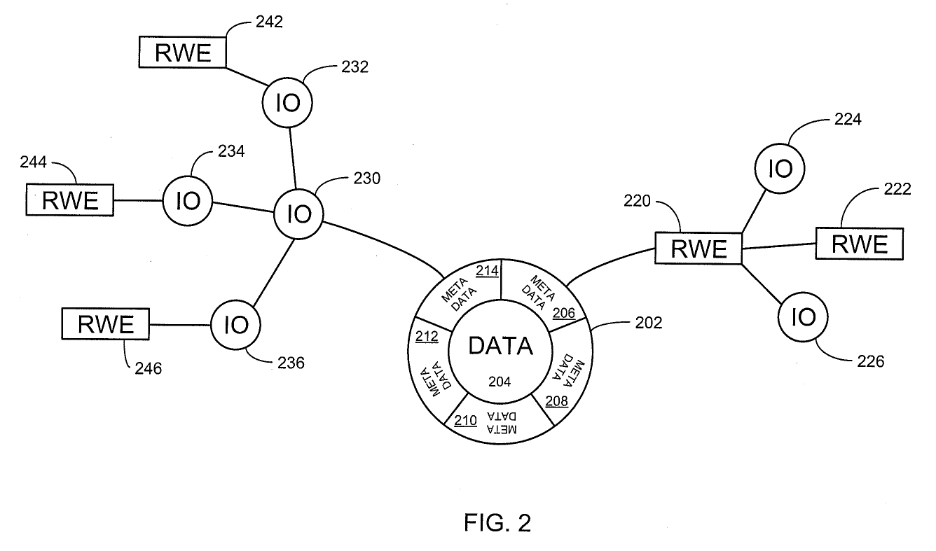

FIG. 2 illustrates one embodiment of metadata defining the relationships between RWEs and IOs on the W4 COMN. In the embodiment shown, an IO 202 includes object data 204 and five discrete items of metadata 206, 208, 210, 212, 214. Some items of metadata 208, 210, 212 can contain information related only to the object data 204 and unrelated to any other IO or RWE. For example, a creation date, text or an image that is to be associated with the object data 204 of the IO 202.

Some of items of metadata 206, 214, on the other hand, can identify relationships between the IO 202 and other RWEs and IOs. As illustrated, the IO 202 is associated by one item of metadata 206 with an RWE 220 that RWE 220 is further associated with two IOs 224, 226 and a second RWE 222 based on some information known to the W4 COMN. For example, could describe the relations between an image (IO 202) containing metadata 206 that identifies the electronic camera (the first RWE 220) and the user (the second RWE 224) that is known by the system to be the owner of the camera 220. Such ownership information can be determined, for example, from one or another of the IOs 224, 226 associated with the camera 220.

FIG. 2 also illustrates metadata 214 that associates the IO 202 with another IO 230. This IO 230 is itself associated with three other IOs 232, 234, 236 that are further associated with different RWEs 242, 244, 246. This part of FIG. 2, for example, could describe the relations between a music file (IO 202) containing metadata 206 that identifies the digital rights file (the first IO 230) that defines the scope of the rights of use associated with this music file 202. The other IOs 232, 234, 236 are other music files that are associated with the rights of use and which are currently associated with specific owners (RWEs 242, 244, 246).

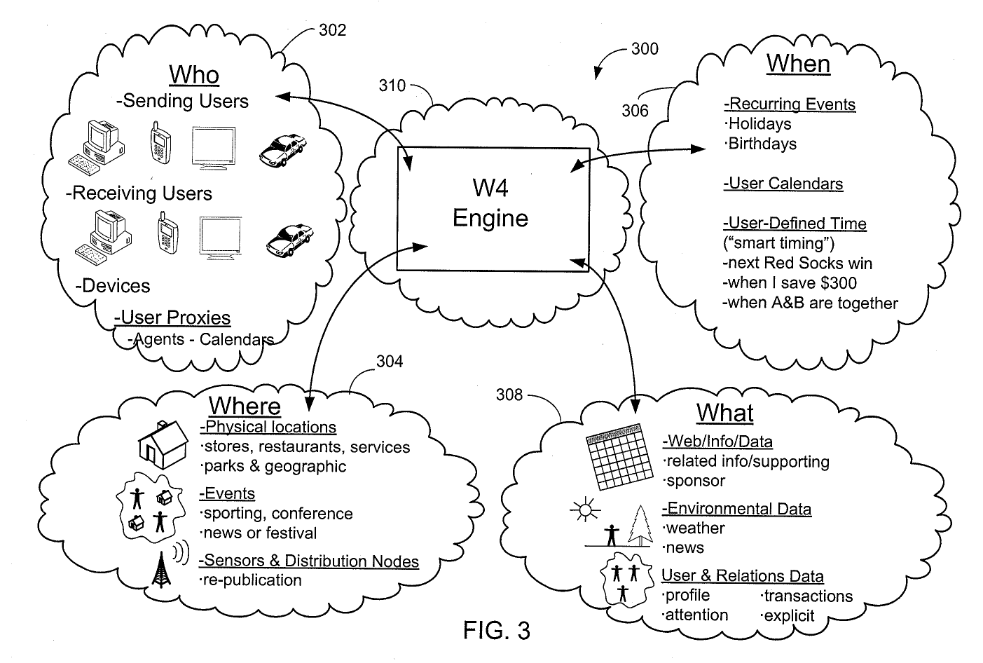

FIG. 3 illustrates one embodiment of a conceptual model of a W4 COMN. The W4 COMN 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc.

In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs).

The What cloud 308 is comprised of all known data—web or private, commercial or user—accessible to the W4 COMN, including for example environmental data like weather and news, RWE-generated data, IOs and IO data, user data, models, processes and applications. Thus, conceptually, most data is contained in the What cloud 308.

Some entities, sensors or data may potentially exist in multiple clouds either disparate in time or simultaneously. Additionally, some IOs and RWEs can be composites in that they combine elements from one or more clouds. Such composites can be classified as appropriate to facilitate the determination of associations between RWEs and IOs. For example, an event consisting of a location and time could be equally classified within the When cloud 306, the What cloud 308 and/or the Where cloud 304.

In one embodiment, a W4 engine 310 is center of the W4 COMN's intelligence for making all decisions in the W4 COMN. The W4 engine 310 controls all interactions between each layer of the W4 COMN and is responsible for executing any approved user or application objective enabled by W4 COMN operations or interoperating applications. In an embodiment, the W4 COMN is an open platform with standardized, published APIs for requesting (among other things) synchronization, disambiguation, user or topic addressing, access rights, prioritization or other value-based ranking, smart scheduling, automation and topical, social, spatial or temporal alerts.

One function of the W4 COMN is to collect data concerning all communications and interactions conducted via the W4 COMN, which can include storing copies of IOs and information identifying all RWEs and other information related to the IOs (e.g., who, what, when, where information). Other data collected by the W4 COMN can include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

The W4 engine 310 is also responsible for identifying RWEs and relationships between RWEs and IOs from the data and communication streams passing through the W4 COMN. The function of identifying RWEs associated with or implicated by IOs and actions performed by other RWEs may be referred to as entity extraction. Entity extraction can include both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object with only where only W4 metadata related to the object is visible, but internal data of the IO (i.e., the actual primary or object data contained within the object) are not, and thus metadata extraction is limited to the metadata. Alternatively, if internal data of the IO is visible, it can also be used in entity extraction, e.g. strings within an email are extracted and associated as RWEs to for use in determining the relationships between the sender, user, topic or other RWE or IO impacted by the object or process.

In the embodiment shown, the W4 engine 310 can be one or a group of distributed computing devices, such as a general-purpose personal computers (PCs) or purpose built server computers, connected to the W4 COMN by communication hardware and/or software. Such computing devices can be a single device or a group of devices acting together. Computing devices can be provided with any number of program modules and data files stored in a local or remote mass storage device and local memory (e.g., RAM) of the computing device. For example, as mentioned above, a computing device can include an operating system suitable for controlling the operation of a networked computer, such as the WINDOWS XP or WINDOWS SERVER operating systems from MICROSOFT CORPORATION.

Some RWEs can also be computing devices such as, without limitation, smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a wi-fi, a WiMAX (802.36), a Bluetooth or a cellular telephone connection.

Local data structures, including discrete IOs, can be stored on a computer-readable medium (not shown) that is connected to, or part of, any of the computing devices described herein including the W4 engine 310. For example, in one embodiment, the data backbone of the W4 COMN, discussed below, includes multiple mass storage devices that maintain the IOs, metadata and data necessary to determine relationships between RWEs and IOs as described herein.

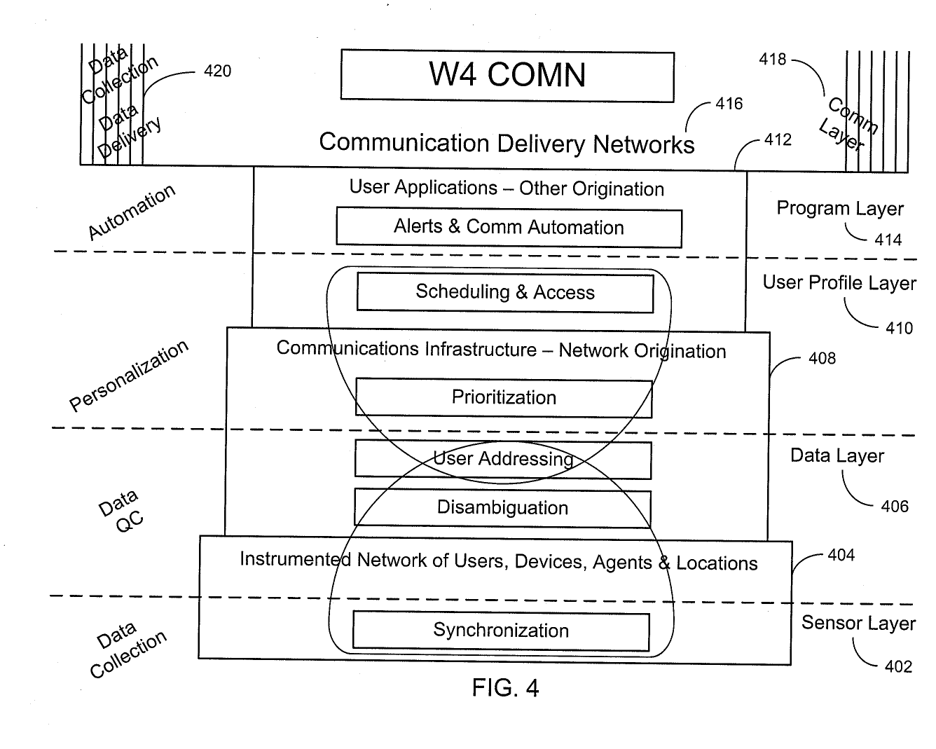

FIG. 4 illustrates one embodiment of the functional layers of a W4 COMN architecture. At the lowest layer, referred to as the sensor layer 402, is the network 404 of the actual devices, users, nodes and other RWEs. Sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The data layer 406 stores and catalogs the data produced by the sensor layer 402. The data can be managed by either the network 404 of sensors or the network infrastructure 406 that is built on top of the instrumented network of users, devices, agents, locations, processes and sensors. The network infrastructure 408 is the core under-the-covers network infrastructure that includes the hardware and software necessary to receive that transmit data from the sensors, devices, etc. of the network 404. It further includes the processing and storage capability necessary to meaningfully categorize and track the data created by the network 404.

The user profiling layer 410 performs the W4 COMN's user profiling functions. This layer 410 can further be distributed between the network infrastructure 408 and user applications/processes 412 executing on the W4 engine or disparate user computing devices. Personalization is enabled across any single or combination of communication channels and modes including email, IM, texting (SMS, etc.), photobloging, audio (e.g. telephone call), video (teleconferencing, live broadcast), games, data confidence processes, security, certification or any other W4 COMM process call for available data.

In one embodiment, the user profiling layer 410 is a logic-based layer above all sensors to which sensor data are sent in the rawest form to be mapped and placed into the W4 COMN data backbone 420. The data (collected and refined, related and deduplicated, synchronized and disambiguated) are then stored in one or a collection of related databases available applications approved on the W4 COMN. Network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from outside the network, e.g., RWEs such as users, locations, proxies and processes, come from the applications layer 414 of the W4 COMN. Some applications can be developed by the W4 COMN operator and appear to be implemented as part of the communications infrastructure 408, e.g. email or calendar programs because of how closely they operate with the sensor processing and user profiling layer 410. The applications 412 also serve as a sensor in that they, through their actions, generate data back to the data layer 406 via the data backbone concerning any data created or available due to the applications execution.

In one embodiment, the applications layer 414 can also provide a user interface (UI) based on device, network, carrier as well as user-selected or security-based customizations. Any UI can operate within the W4 COMN if it is instrumented to provide data on user interactions or actions back to the network. In the case of W4 COMN enabled mobile devices, the UI can also be used to confirm or disambiguate incomplete W4 data in real-time, as well as correlation, triangulation and synchronization sensors for other nearby enabled or non-enabled devices.

At some point, the network effects enough enabled devices allow the network to gather complete or nearly complete data (sufficient for profiling and tracking) of a non-enabled device because of its regular intersection and sensing by enabled devices in its real-world location.

Above the applications layer 414, or hosted within it, is the communications delivery network 416. The communications delivery network can be operated by the W4 COMN operator or be independent third-party carrier service. Data may be delivered via synchronous or asynchronous communication. In every case, the communication delivery network 414 will be sending or receiving data on behalf of a specific application or network infrastructure 408 request.

The communication delivery layer 418 also has elements that act as sensors including W4 entity extraction from phone calls, emails, blogs, etc. as well as specific user commands within the delivery network context. For example, “save and prioritize this call” said before end of call can trigger a recording of the previous conversation to be saved and for the W4 entities within the conversation to analyzed and increased in weighting prioritization decisions in the personalization/user profiling layer 410.

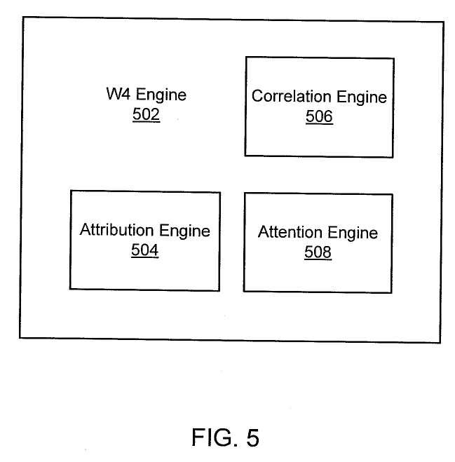

FIG. 5 illustrates one embodiment of the analysis components of a W4 engine as shown in FIG. 3. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the W4 COMN.

The correlation engine 506 can operates two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of the correlation engine 506 is done by graphing the available data, using, for example, one or more histograms A histogram is a mapping technique that counts the number of observations that fall into various disjoint categories (i.e. bins.). By selecting each IO, RWE, and other known parameters (e.g., times, dates, locations, etc.) as different bins and mapping the available data, relationships between RWEs, IOs and the other parameters can be identified. A histogram of all RWEs and IOs is created, from which correlations based on the graph can be made.

As a pre-processor, the correlation engine 506 monitors the information provided by RWEs in order to determine if any conditions are identified that can trigger an action on the part of the W4 engine 502. For example, if a delivery condition has been associated with a message, when the correlation engine 506 determines that the condition is met, it can transmit the appropriate trigger information to the W4 engine 502 that triggers delivery of the message.

The attention engine 508 instruments all appropriate network nodes, clouds, users, applications or any combination thereof and includes close interaction with both the correlation engine 506 and the attribution engine 504.

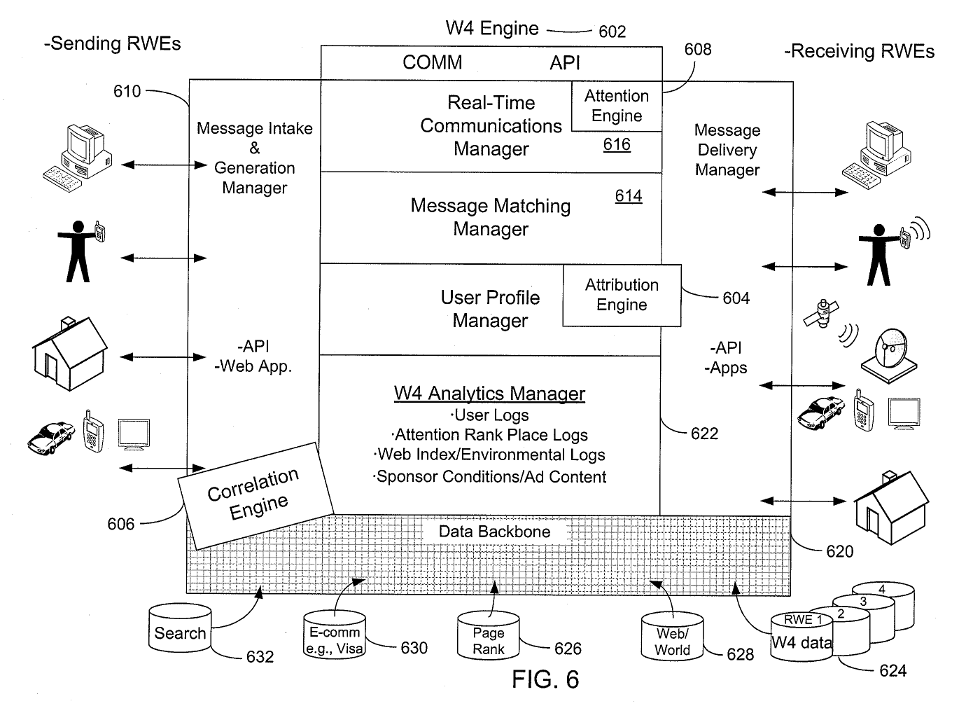

FIG. 6 illustrates one embodiment of a W4 engine showing different components within the sub-engines described above with reference to FIG. 4. In one embodiment the W4 engine 602 includes an attention engine 608, attribution engine 604 and correlation engine 606 with several sub-managers based upon basic function.

The attention engine 608 includes a message intake and generation manager 610 as well as a message delivery manager 612 that work closely with both a message matching manager 614 and a real-time communications manager 616 to deliver and instrument all communications across the W4 COMN.

The attribution engine 604 works within the user profile manager 618 and in conjunction with all other modules to identify, process/verify and represent ownership and rights information related to RWEs, IOs and combinations thereof.

The correlation engine 606 dumps data from both of its channels (sensors and processes) into the same data backbone 620 which is organized and controlled by the W4 analytics manager 622. The data backbone 620 includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any W4COMN process, IO or event. Because of the amount of data that the W4 COMN will potentially store, the data backbone 620 includes numerous database servers and datastores in communication with the W4 COMN to provide sufficient storage capacity.

The data collected by the W4 COMN includes spatial data, temporal data, RWE interaction data, IO content data (e.g., media data), and user data including explicitly-provided and deduced social and relationship data. Spatial data can be any data identifying a location associated with an RWE. For example, the spatial data can include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data can be passively collected time data (e.g., time data from a clock resident on the electronic device, or time data from a network clock), or the temporal data can be actively collected time data, such as time data entered by the user of the electronic device (e.g., a user maintained calendar).

Logical and IO data refers to the data contained by an IO as well as data associated with the IO such as creation time, owner, associated RWEs, when the IO was last accessed, the topic or subject of the IO (from message content or “re” or subject line, as some examples) etc. For example, an IO may relate to media data. Media data can include any data relating to presentable media, such as audio data, visual data, and audiovisual data. Audio data can be data relating to downloaded music, such as genre, artist, album and the like, and includes data regarding ringtones, ringbacks, media purchased, playlists, and media shared, to name a few. The visual data can be data relating to images and/or text received by the electronic device (e.g., via the Internet or other network). The visual data can be data relating to images and/or text sent from and/or captured at the electronic device.

Audiovisual data can be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data can include data relating to the user's RSS feeds, subscriptions, group memberships, game services, alerts, and the like.

The media data can include non-network activity, such as image capture and/or video capture using an electronic device, such as a mobile phone. The image data can include metadata added by the user, or other data associated with the image, such as, with respect to photos, location when the photos were taken, direction of the shot, content of the shot, and time of day, to name a few. Media data can be used, for example, to deduce activities information or preferences information, such as cultural and/or buying preferences information.

Relationship data can include data relating to the relationships of an RWE or IO to another RWE or IO. For example, the relationship data can include user identity data, such as gender, age, race, name, social security number, photographs and other information associated with the user's identity. User identity information can also include e-mail addresses, login names and passwords. Relationship data can further include data identifying explicitly associated RWEs. For example, relationship data for a cell phone can indicate the user that owns the cell phone and the company that provides the service to the phone. As another example, relationship data for a smart car can identify the owner, a credit card associated with the owner for payment of electronic tolls, those users permitted to drive the car and the service station for the car.

Relationship data can also include social network data. Social network data includes data relating to any relationship that is explicitly defined by a user or other RWE, such as data relating to a user's friends, family, co-workers, business relations, and the like. Social network data can include, for example, data corresponding with a user-maintained electronic address book. Relationship data can be correlated with, for example, location data to deduce social network information, such as primary relationships (e.g., user-spouse, user-children and user-parent relationships) or other relationships (e.g., user-friends, user-co-worker, user-business associate relationships). Relationship data also can be utilized to deduce, for example, activities information.

Interaction data can be any data associated with user interaction of the electronic device, whether active or passive. Examples of interaction data include interpersonal communication data, media data, relationship data, transactional data and device interaction data, all of which are described in further detail below. Table 1, below, is a non-exhaustive list including examples of electronic data.

TABLE 1
Examples of Electronic Data

| Spatial Data | Temporal Data | Interaction Data |
|---|---|---|
| Cell tower | Time stamps | Interpersonal |
| GPRS | Local clock | communications |
| GPS | Network clock | Media |
| WiFi | User input of time | Relationships |
| Personal area network | | Transactions |
| Network access points | | Device interactions |
| User input of location | | |
| Geo-coordinates | | |

Interaction data includes communication data between any RWEs that is transferred via the W4 COMN. For example, the communication data can be data associated with an incoming or outgoing short message service (SMS) message, email message, voice call (e.g., a cell phone call, a voice over IP call), or other type of interpersonal communication related to an RWE. Communication data can be correlated with, for example, temporal data to deduce information regarding frequency of communications, including concentrated communication patterns, which can indicate user activity information.

The interaction data can also include transactional data. The transactional data can be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data can be utilized, for example, to deduce activities and preferences information. The transactional information can also be used to deduce types of devices and/or services the user owns and/or in which the user can have an interest.

The interaction data can also include device or other RWE interaction data. Such data includes both data generated by interactions between a user and a RWE on the W4 COMN and interactions between the RWE and the W4 COMN. RWE interaction data can be any data relating to an RWE's interaction with the electronic device not included in any of the above categories, such as habitual patterns associated with use of an electronic device data of other modules/applications, such as data regarding which applications are used on an electronic device and how often and when those applications are used. As described in further detail below, device interaction data can be correlated with other data to deduce information regarding user activities and patterns associated therewith. Table 2, below, is a non-exhaustive list including examples of interaction data.

TABLE 2
Examples of Interaction Data

| Type of Data | Example(s) |
|---|---|
| Interpersonal | Text-based communications, such as SMS and e- |
| communication data | mail |
| | Audio-based communications, such as voice |
| | calls, voice notes, voice mail |
| | Media-based communications, such as |
| | multimedia messaging service (MMS) |
| | communications |
| | Unique identifiers associated with a |
| | communication, such as phone numbers, e-mail |
| | addresses, and network addresses |
| Media data | Audio data, such as music data (artist, genre, |
| | track, album, etc.) |
| | Visual data, such as any text, images and video |
| | data, including Internet data, picture data, |
| | podcast data and playlist data |
| | Network interaction data, such as click patterns |
| | and channel viewing patterns |
| Relationship data | User identifying information, such as name, age, |
| | gender, race, and social security number |
| | Social network data |
| Transactional data | Vendors |
| | Financial accounts, such as credit cards and banks |
| | data |
| | Type of merchandise/services purchased |
| | Cost of purchases |
| | Inventory of purchases |
| Device interaction data | Any data not captured above dealing with user |
| | interaction of the device, such as patterns of use |
| | of the device, applications utilized, and so forth |

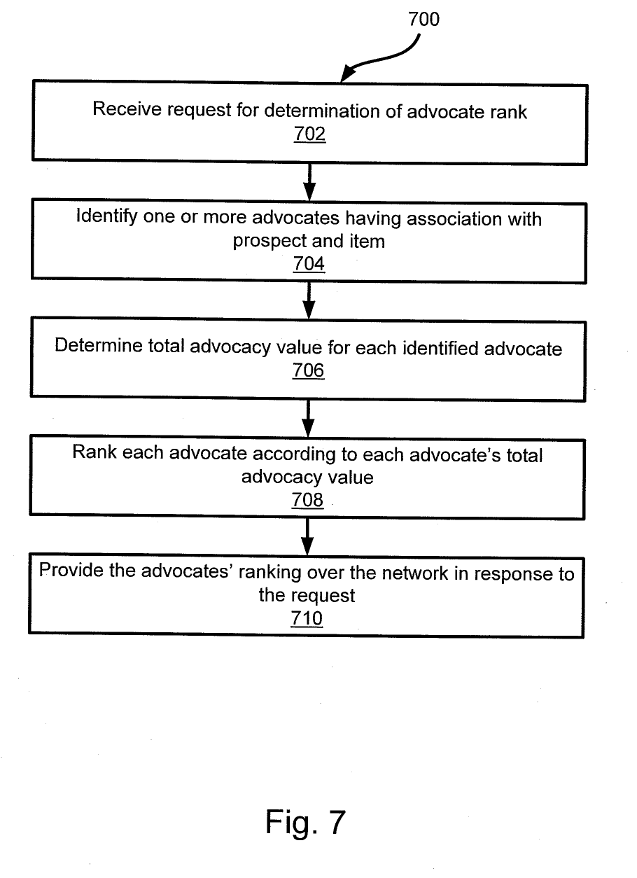

FIG. 7 illustrates one embodiment of a method for ranking advocates that are identified as having an association with a prospect and an item, and providing this ranking over a network. The method 700 can include receiving a request for a determination of advocate rank via a receive request operation 702. Such a request may be received over a network (e.g., Internet, intranet, cellular network, satellite network, or any combination of networks). In an embodiment, the request can be generated by a computing system. The interactions of RWEs with the network or IOs available by the network may be the impetus for the request. For instance, a prospect may enter a store, and the prospect's cell phone may generate a request for one or more advocates. Alternatively, a system in a store may determine the advocate's presence and request. In an embodiment, a request may be generated periodically in order to refresh the advocates' ranking. Alternatively, a request may be generated in a non-periodic fashion.

In order to facilitate further discussion, let us assume the following specific example: a prospect, Alfred, is an avid runner and is looking for a pair of replacement running shoes. Alfred is looking into a pair running shoes made by LongLife Sporting Goods. LongLife Sporting Goods relies on the advocacy of many advocates including Buford and Chloe.

Returning to the method 700, the method 700 can identify one or more advocates having an association with the item and prospect via an identification operation 704. In an embodiment, advocates having an association with the prospect may know, be friends with, be related to, belong to the same peer/social group as the prospect, for example. Advocates having an association with the item may have purchased, surveyed, observed, used, tested, sold, advocated, and/or reviewed the item, for example. For instance, the identification operation 704 may identify advocates as friends or classmates of the prospect. The identification operation 704 can also identify advocates who are not only friend/classmates of the prospect, but have also made purchases of items related to the prospect's interests. In an embodiment, advocates can be associated with both a prospect and an item. In an embodiment, an advocate may not have a direct association with an item, but rather knows of the item through knowledge gleaned from a co-worker who owns/used the item. Other indirect associations are also implicitly included herein.

There may be situations in which only a single advocate is identified. In other situations an excessive number of advocates may be identified. In such a case, the identify operation 704 may alter the identification criteria and again identify advocates using the altered criteria. Thus, the identify operation 704 may repeat with altered criteria until a reasonable number of advocates are identified. In some instances, there may not be advocates that meet the identification criteria. In such a case, the identify operation 704 may alter the identification criteria and again identify advocates using the altered criteria. Thus, the identify operation 704 may repeat with altered criteria until at least one advocate is identified. In another embodiment, the identify operation 704 may repeat until a threshold number of advocates have been identified. For instance, on a first iteration, the identify operation 704 may identify two advocates, yet the threshold may require ten advocates. The identify operation 704 could then alter the criteria with the goal of identifying more advocates. On a second iteration, thirteen advocates may be identified, the threshold will have been surpassed, and the next operation can be carried out.

Once one or more advocates have been identified, the method 700 may determine a total advocacy value for each advocate via a determine total advocacy value operation 706. The determine operation 706 determines total advocacy value via a processor by applying to a model information available via the network. Information can be derived from RWEs' interactions with the network, and IOs accessible by the network.

A variety of information can be derived from RWEs' interactions with the network. For instance, spatial relationships between RWEs or the speed of RWEs. Information can include an advocate's interactions with the network (e.g., what websites does the advocate visit and spend the most time on). Information can include age, education, income level, race, geographical location, familial relationships, and family structure, to name a few. Other information has been previously described with reference to FIGS. 1-6. This limited set of examples show just some of the many forms of data/information that can be used to determine an advocate's likelihood of inducing a prospect to engage in a transaction (total advocacy value).

A variety of methods can be used to derive information from RWEs' interactions with the network. For instance, a keyword search of an email sent by an advocate can determine whether the advocate mentioned a particular product, service, or brand and what the advocate said about the product, service, or brand. Text messages sent by an advocate can be monitored in a similar fashion. Conversations that an advocate carries on via voiceover Internet protocol (VOIP), cell phone, or landline communications can be monitored and analyzed for signs of advocacy. For instance, voice recognition software could be used to convert verbal communications into textual data that can be analyzed by a textual analyzer or keyword search.

A variety of IOs are accessible by the network. For instance the time of day can be acquired via a network. As another example, evidence of an online purchase can further be acquired from a network. Other IOs accessible by the network were previously described with reference to FIG. 1-6.

Various conclusions can be drawn based on the above-described information. For instance, information can be utilized to determine an advocate's relationship and knowledge with particular products, brands, and services. An advocate's relationship to other people can also be determined from this information. This information can be used to answer questions such as: who does an advocate communicate with most often; who does an advocate spend the most time with; and what activities does an advocate engage in and what people does he interact with while doing those activities.

In an embodiment, total advocacy value is based on an advocate's prior history of advocacy for an item or an advertiser. Such a determination could consider actions that the advocate took to try and convince prospects to engage in a transaction. Alternatively, the determination could consider whether or not a transaction resulted from the advocate's attempts. Alternatively, the determination could consider the value of transactions resulting from the advocate's attempts. Alternatively, the determination could consider the advocate's success regarding advocating a type of item (e.g., sporting equipment, women's clothing, used cars). Alternatively, the determination could consider the advocate's success regarding advocating to a type of prospect (e.g., middle-income commuter, high-income yet thrifty executive, stay-at-home dad with lofty credit card limit) or a type of relationship with a prospect (e.g., friend, co-worker, member of extended family). Alternatively, the determination could consider any combination of the above factors.

More than one total advocacy value can be determined for each advocate. For instance, an advocate can have a total advocacy value for each advertiser than an advocate advocates for. An advocate can have a total advocacy value for different items (i.e., different products, services, and brands). An advocate can have a total advocacy value for different prospects. Total advocacy value can be determined, stored, and update. Alternatively, total advocacy value can be determined upon request rather than stored and updated.

In an embodiment, the model can be modified or tailored to meet a user or advertiser's needs. Modifying the model can include setting, determining, programming, or adjusting parameters. Modifying the model can include setting, determining, programming, or adjusting algorithms/functions/equations in the model. For instance, one advertiser may desire advocates with strong relationships to an item, whereas another advertiser may prefer advocates with strong relationships to prospects. Thus, one advertiser may modify the model such that relationships to items are weighted more heavily than relationships to prospects. For example, LongLife Sporting Goods' market research indicates that the quality of an advocate's relationship to the item is more important than the advocate's relationship to the prospect. Thus, LongLife may implement a model that favors advocate's with a proven history of advocacy for the item that a prospect is interested in.

Total advocacy value can be determined on a continual or periodic basis. For instance, information may be applied to the model twice a day thus refreshing total advocacy value twice daily. In an alternative embodiment, total advocacy value can be determined in a non-periodic fashion. For instance, information may be monitored, and anytime that a significant advocate activity is detected, total advocacy value may be recalculated. Alternatively, total advocacy value can be updated based on a fixed schedule of determination operations. For instance, total advocacy value may be determined every thirty seconds between the hours of 4:00 pm and 2:00 am, and determined every six minutes during other hours of the day.

Having determined total advocacy value, the method 700 can rank advocates via a ranking operation 708. The ranking operation 708 can utilize a processor to rank each advocate according to each advocate's total advocacy value and thus create an advocates' rank. For example, there may be three advocates which will be referred to as Advocate A, Advocate B, and Advocate C. Advocate A may have a total advocacy value of 3. Advocate B may have a total advocacy value of 5. Advocate C may have a total advocacy value of 1. In this example, the ranking operation 708 would rank these three advocates in the following order: Advocate B (5), Advocate A (3), Advocate C (1). At a later time, total advocacy values may be refreshed and change to the following: A=3, B=5, C=4. As such, Advocate C would move ahead of Advocate A in the ranking. In an embodiment, the advocates' ranking can be a set of data, a database, or a file. The advocates' ranking can reside on a server connected to the network.

The advocates' ranking can be provided over the network and accessed in order to determine which advocates are most likely to induce a particular prospect to engage in a transaction related to an item. This can be performed by providing the advocates' ranking over the network operation 710. In an embodiment, the providing operation 710 can be carried out in response to the request of the receive request operation 702. The ranking can be accessed by advertisers or systems and methods associated with advertisers searching for advocates to match with prospects. Such access can be manually or autonomously carried out. In other words, an advertiser can use an automated system, wherein one or more highest-ranked advocates are automatically linked to prospects.

In an embodiment, communication can be facilitated between one or more highest-ranked advocates and the prospect, wherein the highest-ranked advocates are selected based on the advocates' ranking. In an embodiment, facilitating communication can involve establishing a cell phone link between an advocate and a prospect (e.g., the advocate can be prompted to call or text the prospect). In an embodiment, facilitating communication can involve prompting the advocate to make verbal contact with the prospect (e.g., advocate can be prompted by an automated cell phone call, a text message, or an e-mail). In an embodiment, facilitating communication can involve establishing an electronic message connection (e.g., instant messaging, e-mail, forum postings) between the advocate and prospect.

In an embodiment, facilitating communication can mean automatically establishing a cell phone conversation between the prospect and the advocate. This may take place by providing instructions to the advocate's cell phone to automatically call the prospect. The advocate could then talk about the item to the prospect. In another embodiment, the advocate's cell phone may prompt the advocate to call the prospect via a text message or automated voice message. In an embodiment, an e-mail can be sent to the advocate prompting the advocate to communicate with the prospect. In an embodiment, an outgoing e-mail can be automatically created such that the advocate need only enter a few specific details regarding the item and then send the e-mail to the prospect. Such communications with the advocate can be simple prompts informing the advocate that now is a good time to communicate with the prospect. On the other hand, communications can be more complex: a prompt can be transmitted to the advocate along with information regarding the prospect and the item in question. In this manner, the advocate can better tailor his/her advocating to the prospect and the item. The advocate can also be informed about other items that the prospect is considering. This would allow the advocate to further tailor his/her advocating tactics to distinguish over the competing items.

The method 700 can further comprise a model having a prospective advocacy value for each advocate. The prospective advocacy value can represent the quality of a relationship between each advocate and the prospect. In an embodiment, relationships can be user-defined or explicitly coded (e.g., an advocate or advertiser explicitly specifies relationships such as spouse, friend, co-worker, brother, sister, son, daughter, boss, supervisor, teacher, mentor). For instance, when an advocate becomes an advocate he/she may define all of his/her known friends. In an embodiment, relationships can be autonomously derived or autonomously determined. For instance, by monitoring an advocate's activities it may be found that the advocate spends a certain amount of time with person X. It is also known that the advocate spends less time with friend Y, then with person X. Based on this data and other indicators, it may be determined that person X must also be the advocate's friend. Thus, the relationship between the advocate and person X may be autonomously defined as a friend (or perhaps just an acquaintance since the relationship was not user-defined).

In an embodiment, the parameters governing how autonomously-defined relationships are determined, can be user or advertiser defined. For instance, in the above example one advertiser may code the determination such that the relationship between person X and the advocate is autonomously-defined as a friend while another advertiser may code the determination such that the same set of facts results in the relationship being defined as an acquaintance.

In an embodiment, the quality of relationships can be user defined or based upon explicit coded values. For instance, different advertisers can manually determine what relationships they believed to be most valuable between prospects and advocates. An advertiser may determine that relationships between peers are more valuable than relationships between an authority figure and a subordinate. Alternatively, a relationship between an advocate and prospect of similar age may be deemed a relationship having high value or quality as compared to a relationship between an advocate and prospect of vastly different ages. In another example, relationships between woman may be deemed to have higher quality than between men.

In another embodiment, quality can be autonomously-derived. In an embodiment, autonomous quality determination can utilize information available via the network derived from RWEs' interactions with the network and IOs accessible by the network.

In an embodiment, quality can be based upon both explicitly coded values as well as autonomous determinations. For instance, an advertiser may assign a fixed weighting value to all relationships coded or deemed to be “friend” relationships. Yet, the quality of these relationships could be differentiated based on autonomous monitoring of advocate activities. For example, even if the advertiser assigned a first relationship between an advocate and a friend the same quality as a second relationship between the advocate and another friend, autonomous monitoring may show that the quality of the second relationship is greater because the advocate and this other friend spend more time together. In an embodiment, the quality can be based on the intimacy of a relationship, and the frequency of communication between the advocate and prospect.

In an embodiment, the advocate's ranking can be determined for different items. An advocate ranking can also be determined for different advertisers. An advocate ranking can be determined for different prospects. Alternatively, an advocate ranking can be determined for any one or more of these items in combination. For instance, an advocates ranking can be determined based on the item, the advertiser, and the advocates, but not based on the prospect. In other words the ranking would not consider the relationship to the prospect. In another example, a ranking can be based solely on the relationship to the prospect and disregard the item or advertiser.

The method 700 can further include a model comprising an item advocacy value. The item advocacy value can represent the quality of the relationship between each advocate and an item. It should be remembered that an item is the equivalent of a product, brand, or service. Said relationship can be user-defined or autonomously-defined. For instance an advocate who commonly purchases LongLife running shoes may be defined as a “common purchaser”, a “frequent customer”, or a “valued shopper”. An advocate who belongs to a running team sponsored by LongLife Sporting Goods may be defined as a “sponsored advocate.” An advocate that works for LongLife Sporting Goods may be defined as an “employee.”

These different relationships with an item can each be assigned a different quality, wherein quality represents the value of the relationship (e.g., dollar or commercial value of the relationship). For instance, a common purchaser may be assigned a higher quality than a one-time purchaser. In an embodiment, said quality can be explicitly coded or user-defined. For example, an advertiser can determine that all relationships deemed to be from common purchasers are to receive a higher quality than relationships deemed to be from one-time purchasers. Alternatively, the quality can be autonomously determined.

In an embodiment, the quality of a relationship with an item can be based on co-presence of the advocate and a prospect. Co-presence is the act of two people being in relatively close proximity to each other. For instance, two people being in the same room can be an example of co-presence. However, depending on how a system or method defines co-presence, a closer proximity may be required. Co-presence may require that two people be within two feet of each other. On the other hand co-presence may be defined by a location or physical boundary rather than a distance from each other. For example, two persons being at the same concert could be co-present. In an embodiment, co-presence can be physical. Physical co-presence describes the relative proximity of two people in physical space. In an embodiment, co-presence can be virtual. Virtual co-presence describes two people being in proximity to each other via a non-physical connection such as via a network. As a non-limiting example, when two people converse via an instant messaging system on the Internet, then they can be said to be co-present with each other.

In determining the item advocacy value, the model can further give different weight to each advocate's prior advocating activities depending on a type of prior advocacy. The prior type of advocacy, includes, but is not limited to, the method, means, or medium through which an advocate advocated to a prior prospect. For instance, one type of advocacy is face-to-face verbal communication. Another is face-to-face demonstration including taking a prospect to see the item (whether via a computer and the Internet or the physical item in a store or in someone's possession). Other types of advocacy include instant messaging, verbal communication via cell phone or VOIP, or email messages, to name a few. Each types of advocacy has a different value to the advertiser since some types of advocacy have a greater chance of inducing the prospect to engage in a transaction. For instance, a verbal communication between the advocate and a prospect may be given greater weight than a text message. Similarly, bringing a prospect to the storefront where an item is sold may have greater weight than a simple verbal communication regarding the item. In an embodiment, the weight of the type of advocacy in the item advocacy determination can be user-defined (e.g., the advertiser may assign weights to different types of advocacy).

In determining the item advocacy value, the model can consider the results of an advocate's prior advocacy. For instance, greater weight may be given to advocacy activities that result in a transaction than activities that don't result in a transaction.

Another aspect of the disclosure involves determining an appropriate or ideal time for an advocate to communicate with a prospect. An appropriate or ideal time can be a time at which advocacy is estimated to have the most influence on a prospect in inducing that prospect to make a transaction. For instance, advocacy may only have a marginal effect when a prospect first expresses interest in an item. Advocacy may have a far greater effect at a later time, say moments before an advocate chooses between two different items made by different companies. In this instance, an ideal time may be the moment at which an advocate has narrowed his/her search to two products. On the other hand, advocacy may have the greatest effect when a prospect has a slew of choices before him. In this instance, the ideal time may be very shortly after a prospect first expresses interest in an item. The ideal time can be user-defined or autonomously-defined.

Once an appropriate or ideal time has been identified or determined, communication between one or more of the highest-ranked advocates and the prospect can be facilitated at a time based on the most valuable time. In an embodiment, communication can be facilitated at the most valuable time. In another embodiment, communication can be facilitated before the most valuable time. In another embodiment, communication can be facilitated after the most valuable time. An algorithm can be used to determine when, relative to the appropriate or ideal time, communication should be facilitated. Communication methods can include, but are not limited to, text messages, e-mail, picture or data messages sent via cell phone or smart phone, face-to-face verbal communication, remote verbal communication (e.g., cell phone, VOIP).

In an embodiment, the advocates' ranking can be determined for each of the one or more Who, What, Where, When clouds of the W4 COMN. For example, a ranking based on the Who cloud can provide a ranking of advocates best suited for advocating an item related to a person (e.g., Mom, a best friend, a movie star, a disliked politician, the premier yoga guru of Boulder, Colo.). Alternatively, a ranking based on the What cloud can provide a ranking of advocates best suited for advocating given a state of an RWE (e.g., a car that is low on fuel, a computer that is three years old or has experienced at least five viral attacks). As another example, a ranking based on the Where cloud can provide a ranking of advocates best suited for advocating an item sold at or relating to a location (e.g., the LongLife Sporting Goods physical storefront, the Virgin Megastore in Greenwiche Village, NYC). Alternatively, a ranking based on the When cloud can provide a ranking of advocates best suited for advocating an item sold at or relating to a time, day, or season (e.g., Christmas Day, Halloween, after school, breakfast, Summer).

In a similar embodiment, information can include the spatial relation between the advocate and the prospect. The spatial relation between an advocate and prospect can be determined using positioning systems (e.g., global position satellites) associated with the prospect and the advocate or RWEs associated with the prospect and the advocate (e.g., cell phones). Alternatively, the spatial relation between a prospect and advocate can be determined from timing differences between transmission and receipt of electronic signals sent between the prospect and advocate or between either of these parties and a node of a communications network being used by either the prospect or advocate, or both. For instance, if either of these individuals has a cell phone that is actively transmitting signals, two or more communications network receivers (e.g., cell phone towers) can receive these signals and utilize algorithms to determine an approximate position of the prospect or advocate. In the case of at least three cell phone towers or other communications receivers, triangulation can be performed to determine an even more accurate location of either the prospect or the advocate.

In an alternative embodiment, the spatial relation between the advocate and the prospect can be determined by monitoring one or more radio frequency ID tags associated with either the advocate or the prospect or an RWE associated with the advocate or the prospect. For instance, an RFID tag may be embedded in a piece of clothing, in food packaging, or in a piece of electronic equipment that is being carried by the prospect or the advocate, or worn by the prospect or advocate. An RFID tag may even be consumable or implantable in either the prospect or advocate. An RFID tag may be passive or active. For instance, a cell phone may act as an RFID tag monitoring device. An RFID tag implanted in a shirt or jacket worn by a person using the cell phone can be monitored by the cell phone such that it can be known whether or not the individual is wearing that particular article of clothing. As such, when an article of clothing or some other object containing an RFID tag is purchased, received, or taken by any individual, it can be determined when that individual utilizes or wears that particular object with the embedded RFID tag, thus allowing monitoring, analysis and data storage of the frequency of use or wearing of said object.

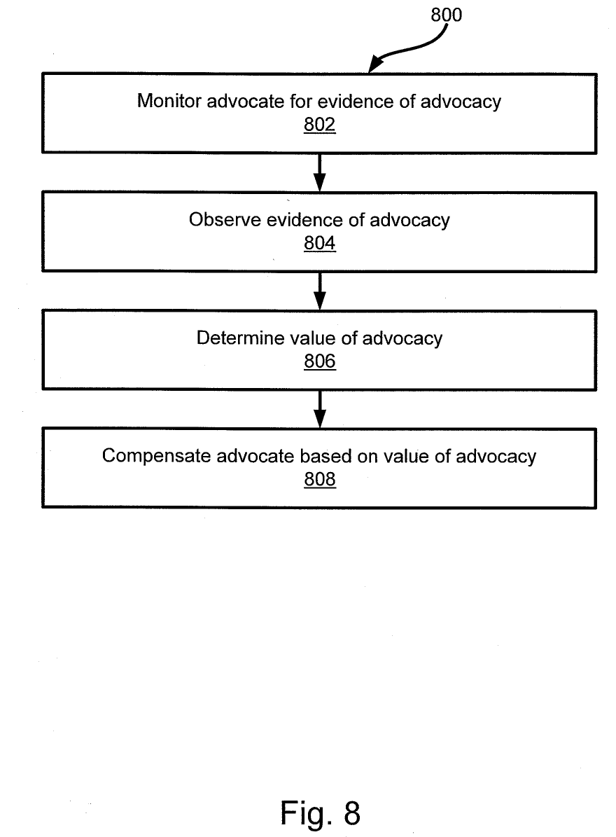

Along with determining which advocates are best suited to a given advocacy situation, this disclosure also encompasses systems and methods for compensating advocates based on their advocacy. FIG. 8 illustrates one embodiment of a method for monitoring advocacy and compensating advocates based on the value of their observed advocacy. In an embodiment, the method 800 includes a monitor advocate operation 802 in which, via a network, an advocate is monitored for evidence of advocacy. Evidence of advocacy can include any data associated with an advocate that can be utilized to determine the value of an advocate's advocacy. Examples include taking a prospect to a storefront location, standing beside a prospect and discussing an item viewed via the Internet, verbal advocacy via cell phone, face-to-face advocacy, wearing or displaying an item in public, and wearing or displaying an item in the company of certain prospects, to name a few. These examples show that evidence of advocacy can be observed without the advocate even knowing that he/she was engaged in advocacy. Yet, the method 800 can determine that these activities have value and are thus evidence of advocacy. Evidence of advocacy can also include data regarding whether or not a transaction took place as the result of advocacy.

The monitor operation 802 can collect data, wherein the data represents RWEs' interactions with a network and/or IOs accessible by the network. This data can then be analyzed to determine if there was evidence of advocacy and determine the value of advocacy that is observed.

In an embodiment, data can also be acquired in order to better valuate evidence of advocacy. For instance, an advocate may spend a great deal of time at a particular school and less time at a local shopping center. The mere fact that the advocate is in either of these locations may not be evidence of advocacy directly; however, data indicating the frequency with which that advocate locates him- or herself in those two locations could be utilized in the future to determine when the advocate is engaged in advocating activities. Thus, monitoring an advocate for evidence of advocacy goes beyond mere observation of direct advocacy. Indirect advocacy or any data that can be utilized to determine when an advocate is advocating and what the quality of that advocacy is can be taken as part of the monitoring operation 802. Monitoring can be performed via a network, such as the Internet, or cell phone network.

Evidence of advocacy can be observed in an observe operation 804. Observing evidence of advocacy can mean analyzing the data collected in the monitor operation 802, and determining whether evidence of advocacy occurred. For instance, an advocate's location may be monitored. The location data can be analyzed to determine where the advocate was and who the advocate was with during a given time period. The location data may indicate that the advocate was within a few feet of a prospect X during a one hour period, and that during that one hour prospect X made a purchase at LongLife Sporting Goods. This data could be deemed to be evidence of advocacy.

If evidence of advocacy is observed, the value of the advocacy can then be determined via determine operation 806. The determine operation 806 determines, via a processor, a value of the evidence of advocacy by applying to a model information available via the network. The information can be derived from RWEs' interactions with the network and IOs accessible by the network. In an embodiment, information can be applied to the model in a manner similar to the previously-described method for determining total advocacy value (i.e., determining the likelihood that an advocate will induce a prospect to engage in a transaction with a particular item). In another embodiment, the value of the advocacy can be related to the value of the item purchased as a result of an advocate's activities. So, for instance, an advocate may send two text messages to a prospect: one text advocating the purchase of LongLife High-reflectivity shoelaces (in purple) for $11.99, the other text advocating the purchase of LongLife All-Terrain All-Weather Studded Cross Training Shoes for $149.99. The prospect purchases both items. Yet, the value of the second text message was far greater because of the transaction's higher sales price. Thus, even though the same method was used in both instances of advocacy, and the prospect was the same in both instances, the value of advocacy was vastly different. In another embodiment, the value of advocacy can be related to both the likelihood of inducing a transaction, as well as the value of the item in question. For instance, given the same facts as the example above, with the modification that the advocacy for the shoelaces was made via a face-to-face conversation, the value of the advocacy of the face-to-face communication can be worth nearly as much as the text message since the face-to-face advocacy is more likely to induce a transaction than the text message (and despite the text's higher dollar value).

The value of the advocacy can be used to determine an amount or means for compensating an advocate. Hence, the method 800 can include a compensate advocate operation 808 in which an advocate is compensated based on the value of the advocacy. In an embodiment, compensation can be monetary. In an embodiment, compensation can be non-monetary (e.g., rebates or coupons at a merchant's store, access to restricted on-line resources, free or reduced-rate advertising). In an embodiment, the amount to compensate an advocate can a linear relationship to the value of the advocacy. Thus, as the value of advocacy increases by a factor of 2, the compensation would also increase by a factor of 2. On the other hand, a non-linear relationship can exist between the two values. In such a case, the value of advocacy can increase by a value of 2, yet the compensation value can increase by a factor of 4 or, alternatively, by a factor of 0.5. In an embodiment, the relation between value of advocacy and the compensation can be determined by the advertiser. In an embodiment, the relation between these two values can be determined in a different manner for each advocate. For example, those advocates with great advocating skills and a history of numerous and valuable advocating activities may be rewarded with a better relationship between the value of advocacy and the compensation than, for instance, an advocate who is either not very good at advocating or has not been advocating for very long. The relationship can also depend upon other factors such as results of advocacy, dollar value of advocacy, type of advocacy, and frequency of advocacy, to name a few.

In an embodiment, advocates can be compensated for any and all evidence of advocacy. In another embodiment, advocates can be compensated only for certain evidence of advocacy or certain values of advocacy. In an embodiment, the value of advocacy can be required to meet a particular advocacy compensation threshold value before compensation is awarded to the advocate. So, for instance, an advocate may not be compensated for advocacy unless the value of that advocacy exceeds $0.50, for example. In one embodiment, an advocate can only be compensated when a cumulative value of his advocacy exceeds a particular advocacy compensation threshold value. For instance, a threshold value may be 1,000 abstract units. It may take an advocate numerous or even hundreds of instances of advocacy before the cumulative value of advocacy exceeds that threshold, at which point the advocate could receive compensation.

In another embodiment, the advocate can be compensated when the prospect or value of the advocacy satisfies an advertiser's conditions. An advertiser's conditions can be criteria used to determine when an advocate has performed sufficiently to deserve compensation. For instance, an advertiser can require a threshold value of advocacy (e.g., dollar amount in purchases resulting from advocate's activities). Alternatively, an advertiser can compensate an advocate for every activity that is deemed evidence of advocacy. In one embodiment, advertiser's conditions, that a prospect must fulfill, can include one or more of the following conditions required individually or in combination: making a purchase, signing up for a membership, signing up for a newsletter, signing up to be on an e-mail list, visiting a virtual store, visiting a physical store, testing a product, and taking a survey. Other conditions can also be implemented.

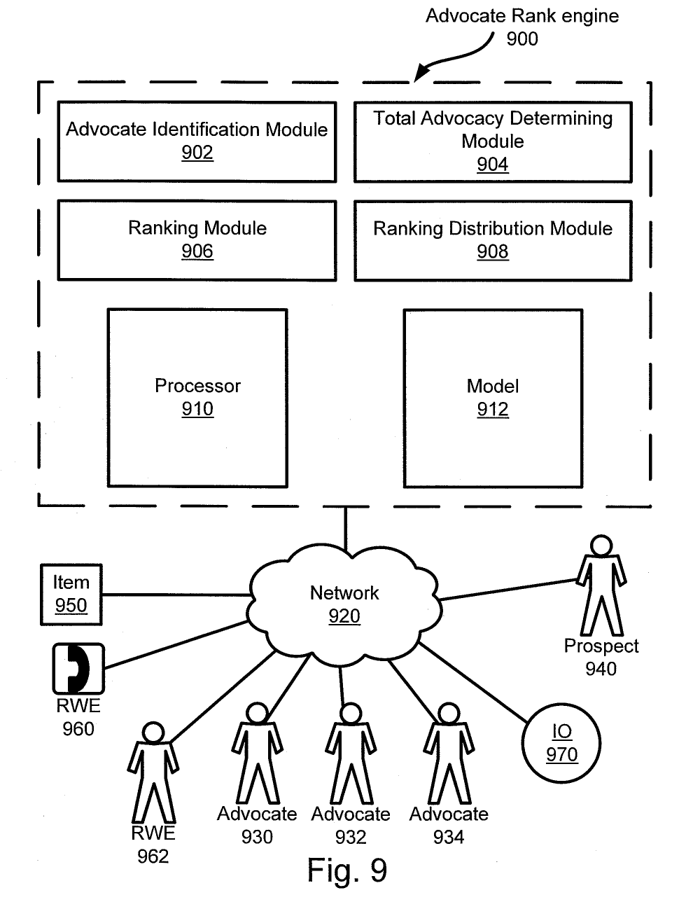

FIG. 9 illustrates one embodiment of an advocate rank engine. The advocate rank engine 900 is capable of carrying out the methods of the disclosure described above. The advocate rank engine 900 can identify one or more advocates having an association with a prospect 340 and/or an item 350. The advocate rank engine 900 can determine a total advocacy value for each identified advocate. The advocate rank engine 900 can rank each advocate according to each advocate's total advocacy value. The advocate rank engine 900 can also provide an advocate's ranking over a network. To accomplish the above, the advocate rank engine 900 is capable of receiving a request over a network 920 for a determination of advocate rank with respect to the item 950 and the prospect 940. Via an advocate identification module 902 the engine 900 can identify one or more advocates 930, 932, 934 having an association with the prospect 940 and the item 950. The engine 900 can also include a total advocacy value determining module 904 capable of determining, via a processor 910, a total advocacy value for each identified advocate 930, 932, 934 by applying to a model 912 information derived from RWEs' 960, 962 interactions with the network 920 and IO 970 accessible by the network 920. The derived information can be applied by the model 912 to estimate a likelihood that each advocate 930, 932, 934 will induce the prospect 940 to engage in a transaction related to the item 950. The advocate rank engine 900 can include a ranking module 906 capable of ranking each advocate 930, 932, 934 according to each advocate's 930, 932, 934 total advocacy value. The advocate rank engine 900 can further include a ranking distribution module 908 capable of providing the advocates 930, 932, 934 ranking over the network 920 in response to the request.

As seen in the illustrated embodiment, the advocate rank engine 900 can be in communication with one or more items; one or more RWEs 960, 962; one or more advocates 930, 932, 934; one or more IOs 970; and/or one or more prospects 940. The advocate identification module 902, total advocacy value module 904, ranking module 906, ranking distribution module 908, processor 910, and model 912 can all be a part of the advocate rank engine 900. The advocate rank engine 900 can comprise a distributed computing system in which the modules 902, 904, 906, 908, processor 910, and model 912 all reside on separate computers or computing systems, or in which some reside on the same computing system, or in which all of these reside on a single computing system.

It should be understood by one skilled in the art that reference to a computer also includes reference to servers, advertisement servers, multiprocessor computing systems, distributed computing systems, and other computing systems familiar to those skilled in the art. It should also be understood that although a single network 920 is illustrated in FIG. 9, other embodiments can include more than a single network. For instance, there can be an intranet network as well as a more broadly encompassing network, such as the Internet. Some of the components or elements or FIG. 9 can be connected by one of these networks and not by the other. For instance, an intranet can connect advocates 930, 932, 934 while advocate 930 is in communication with other components of the system via a cell phone network and advocate 934 can be in communication with other elements of the system via the Internet or another network. Thus, this disclosure should not be understood to limit the system to the components and configurations illustrated in FIG. 9.

The systems and methods herein disclosed can be carried out by a computer-readable media or medium tangibly comprising computer-readable instructions for carrying out the methods of this disclosure. The computer-readable instructions can enable a system to receive a request over a network for a determination of an advocate rank relative to an item. The computer-readable instruction can further enable a system to identify one or more advocates having an association with the item. In an embodiment, the computer-readable instructions can further enable a system to determine, via a processor, a total advocacy value for each identified advocate. This can be done by applying to a model, information available via the network derived from RWEs' interactions with the network and IOs accessible by the network. The derived information can be applied by the model to estimate a likelihood that each advocate will induce the prospect to engage in a transaction related to the item. The computer-readable instructions can further enable a system to rank, via a processor, each advocate according to each advocate's total advocacy value. The computer-readable instructions can further enable a system to provide the advocates' ranking over the network in response to the request.

In another embodiment, the computer-readable media or medium can tangibly comprise computer-readable instructions for the following: monitoring an advocate via a network for evidence of advocacy; observing evidence of advocacy; determining, via a processor, a value of the advocacy by applying to a model information available via the network derived from RWEs' interactions with the network and IOs accessible by the network; and compensating the advocate based on the value of the advocacy.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either a client or server or both. In this regard, any number of the features of the different embodiments described herein can be combined into single or multiple embodiments, and alternate embodiments having fewer than, or more than, all of the features described herein are possible. Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure. For example, total advocacy value can be based on both prior advocacy (e.g., type of prior advocacy, value of prior advocacy, results of prior advocacy, quality of relationships to prior prospects, quality of relationships to prior items) as well as elements of the present (e.g., type of advocacy requested, current prospect, current item).

Numerous other changes can be made that will readily suggest themselves to those skilled in the art and which are encompassed in the spirit of the invention disclosed and as defined in the appended claims.

What is claimed is:

1. A method comprising:
receiving a request over a network for a determination of an advocate rank relative to an item and a prospect;
identifying one or more advocates having an association with the prospect and the item;
determining, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item;
ranking, via a processor, each advocate according to each advocate's total advocacy value; and
providing the advocates' ranking over the network in response to the request.

2. The method of claim 1 further comprising facilitating communication between one or more highest-ranked advocates and the prospect wherein the highest-ranked advocates are selected based on the advocates' ranking.

3. The method of claim 1, wherein the model comprises a prospective advocacy value for each advocate, wherein the prospective advocacy value represents the quality of a relationship between each advocate and the prospect.

4. The method of claim 3, wherein the quality is based on user-defined relationships and autonomously-derived relationships.

5. The method of claim 3, wherein the quality is based on:
an intimacy of the relationship between the advocate and prospect; and
a frequency of communication between the advocate and prospect.

6. The method of claim 1, wherein the model comprises an item advocacy value, wherein the item advocacy value represents the quality of the relationship between each advocate and the item.

7. The method of claim 6, wherein the item advocacy value is the dollar value of the item.

8. The method of claim 6, wherein in determining an item advocacy value, the model gives different weight to each advocate's prior advocating activities depending on a type of prior advocacy.

9. The method of claim 6, wherein in determining an item advocacy value, the model gives different weight to each advocate's prior advocating activities depending on actual results of the prior advocating activities.

10. The method of claim 6, wherein in determining an item advocacy value, the model gives different weight to each advocate's prior advocating activities depending on the value of prior advocating activities.

11. The method of claim 6, wherein the quality is based on a co-presence of the advocate and a previous prospect.

12. The method of claim 11, wherein co-presence is virtual.

13. The method of claim 11, wherein co-presence is physical.

14. The method of claim 1 further comprising:
predicting a most valuable time at which advocacy is most likely to induce a transaction; and
facilitating communication between one or more of the highest-ranked advocates and the prospect at a time based on the most valuable time.

15. The method of claim 1 wherein an advocates' ranking is determined for each product, brand, or service related to the item.

16. The method of claim 1 wherein the advocates' ranking is determined for one or more Who, What, Where, When clouds of the W4 COMN.

17. The method of claim 1, wherein information includes the spatial relation between the advocate and the prospect.

18. The method of claim 17, wherein the spatial relation between the advocate and the prospect is determined via monitoring one or more RFID tags associated with an RWE, wherein the RWE is associated with a prospect.

19. A method comprising:
monitoring an advocate, via a network, for evidence of advocacy;
observing evidence of advocacy;
determining, via a processor, a value of the advocacy by applying to a model information available via the network derived from real world entities' (RWEs) interactions with the network and information objects (IOs) accessible by the network; and
compensating the advocate based on the value of the advocacy.

20. The method of claim 19 further comprising compensating the advocate when the prospect or value of the advocacy satisfies an advertiser's conditions.

21. The method of claim 20, wherein the advertiser's conditions include one or more of the following: making a purchase, signing up for a membership, signing up for a newsletter, signing up to be on an e-mail list, visiting a virtual store, visiting a physical store, testing a product, and taking a survey.

22. An advocate rank engine comprising:
an advocate identification module that receives a request over a network for a determination of an advocate rank relative to an item, and identifies one or more advocates having an association with a prospect and the item;
a total advocacy value determining module that determines, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item;
a ranking module that ranks each advocate according to each advocate's total advocacy value; and
a ranking distribution module that provides the advocates' ranking over the network in response to the request.

23. The system of claim 22 further comprising an advocate compensation module.

24. The system of claim 22, wherein the ranking module determines an advocates' ranking for every advertiser.

25. The system of claim 22, wherein the ranking module determines an advocates' ranking for every brand.

26. The system of claim 24, wherein the ranking module determines an advocates' ranking for every prospect.

27. The system of claim 22, wherein the total advocacy value determining module determines total advocacy value based on the advocate, advertiser, prospect, transaction type, and transaction value.

28. The system of claim 22, further comprising an advertiser manager capable of:
receiving data describing an advertisement campaign of an advertiser; and
matching advocates to the advertiser as part of the advertisement campaign based upon each advocate's rank.

29. A computer readable media or medium tangibly comprising computer readable instructions for:
receiving a request over a network for a determination of an advocate rank relative to an item;
identifying one or more advocates having an association with a prospect and the item;
determining, via a processor, a total advocacy value for each identified advocate by applying to a model information available via the network derived from real world entities' (RWEs) interactions with the network and information objects (IOs) accessible by the network, the derived information being applied by the model to estimate a likelihood that each advocate will induce the prospect to engage in a transaction related to the item;
ranking, via a processor, each advocate according to each advocate's total advocacy value; and
providing the advocates' ranking over the network in response to the request.

30. The computer readable medium of claim 29 further tangibly comprising computer readable instructions for:
monitoring an advocate, via a network, for evidence of advocacy;
observing evidence of advocacy;
determining, via a processor, a value of the advocacy by applying to a model information available via the network derived from RWEs' interactions with the network and IOs accessible by the network; and
compensating the advocate based on the value of the advocacy.

31. A method comprising:
receiving a request over a network for a determination of an advocate rank relative to an item;
identifying one or more advocates having an association with a prospect and the item;
determining, via a processor, a value of the advocacy by applying to a model information available via the network derived from real world entities' (RWEs) interactions with the network and information objects (IOs) accessible by the network;
ranking, via a processor, each advocate according to each advocate's total advocacy value; and
providing the advocates' ranking over the network in response to the request.

32. The method of claim 31, wherein the advocates' ranking is determined relative to the prospect.
